(19) United States
(12) Patent Application Publication
(10) Pub. No.: US 2023/0383594 A1
(43) Pub. Date: Nov. 30, 2023

(54) LADDER ROPE RETAINING DEVICE FOR VENETIAN BLIND

(71) Applicant: SHEEN WORLD TECHNOLOGY CORPORATION, TAICHUNG CITY (TW)

(72) Inventor: PO-YU CHEN, TAICHUNG CITY (TW)

(21) Appl. No.: 17/752,362

(22) Filed: May 24, 2022

(51) Int. Cl. E06B 9/307; E06B 9/266

(52) U.S. Cl. CPC E06B 9/307; E06B 9/266

(57) ABSTRACT

A ladder rope retaining device includes a support base and a rotating base. The support base has a bottom wall and two opposite straight walls connected with the bottom wall. The bottom wall has two opposite elastic support portions protruding out of the bottom surface thereof. The straight walls each have a pivot trough. A positioning bump is formed at the periphery wall of one pivot trough. The rotating base includes a pivot pivotally disposed in the pivot troughs, and a ladder rope retaining portion formed on the pivot. The pivot has a plurality of positioning recesses arranged in an equally-spaced manner. When the rotating base is rotated relative to the support base, the positioning recesses are alternately engaged with and disengaged from the positioning bump to generate a better operating feel. As they are disengaged from each other, the support base becomes deformed elastically.

### BACKGROUND OF THE INVENTION

### 1. Field of the Invention

The present invention relates to a venetian blind and more particularly, to a ladder rope retaining device for a venetian blind.

### 2. Description of the Related Art

As far as a venetian blind is concerned, when all slats are lowered, they are adapted to be driven by a ladder rope to tile relative to a headrail for providing a light-blocking effect. To go a step further, the top end of the ladder rope is fixed to a rotating base. When the rotating base is driven by a driving shaft to rotate relative to a support base, the ladder rope is driven synchronously by the rotating base, such that all slats are driven by the ladder rope to tilt relative to the headrail. However, the conventional rotating base is rotated relative to the support base in a smooth manner. This will cause a poor operating feel during adjusting angle of the slats.

### SUMMARY OF THE INVENTION

It is a primary objective of the present invention to provide a ladder rope retaining device for a venetian blind, which has a clear operating feel during operation.

To attain the above objective, the ladder rope retaining device of the present invention comprises a support base and a rotating base. The support base includes a bottom wall and two straight walls connected with two opposite sides of the bottom wall. Two ends of the bottom wall each have an elastic support portion protruding out of the bottom surface of the bottom wall. The straight walls both have pivot troughs. The periphery wall of one of the pivot troughs has a positioning hump. The rotating base includes a pivot pivotally disposed in the pivot troughs of the support base and a ladder rope retaining portion formed on the outer surface of the pivot. The outer surface of the pivot has a plurality of the positioning recesses arranged in an equally-spaced manner.

It can be seen from the above that when the rotating base is rotated relative to the support base, the positioning recesses are alternately engaged with and disengaged from the positioning bump. When the positioning recesses are disengaged from the positioning bump, the support base becomes deformed elastically through the elastic support portions. By this way, the ladder rope retaining device of the present invention has a clear operating feel during operation.

Preferably, the pivot has a shaft portion pivotally disposed in the pivot troughs of the support base and provided with the positioning recesses, and two disk portions connected with two ends of the shaft portion and located at the outside of the straight walls of the support wall. The diameters of the disk portions are greater than the diameter of the shaft portion and the diameters of the pivot troughs, such that the pivot can be prevented from separating from the pivot troughs along its axial direction.

Preferably, the rotating base further includes a driving hole penetrating through the shaft portion. The rotating base can be driven to rotate by a driving shaft engaged with the shaft portion.

Preferably, the bottom wall further has two hallow portions adjacent to the elastic support portions for facilitating the elastic deformation of the elastic support portions.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a partially perspective view of a venetian blind using a ladder rope retaining device of the present invention.

FIG. 2 is a perspective view of the ladder rope retaining device of the present invention.

FIG. 3 is an exposed view of the ladder rope retaining device of the present invention.

FIG. 4 is an end view of the ladder rope retaining device of the present invention.

FIG. 5 is similar to FIG. 4, showing the support base is elastically deformed by using the elastic support portions to be abutted against an upper rail.

### DETAILED DESCRIPTION OF THE INVENTION

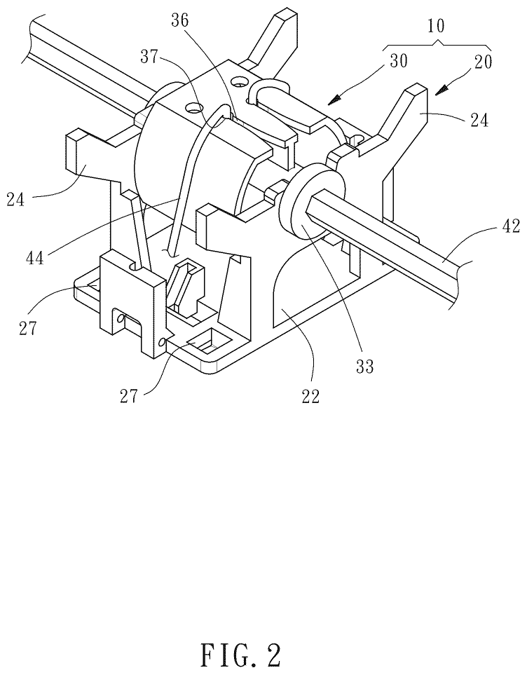

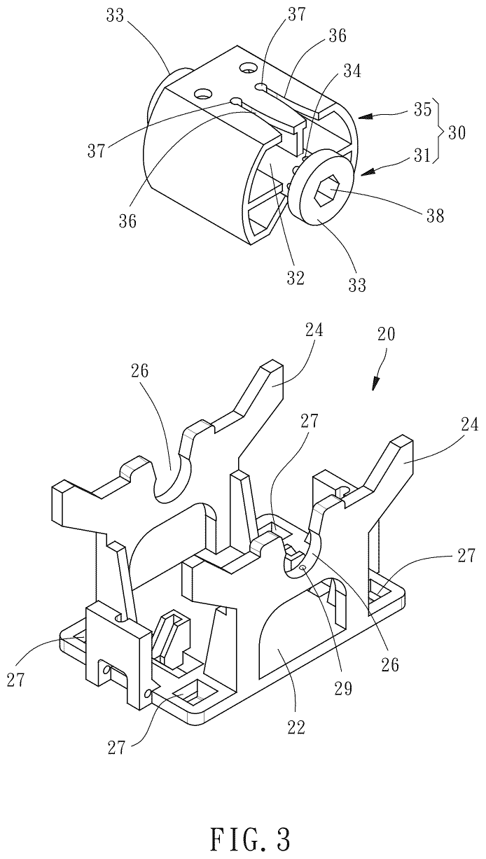

Referring to FIGS. 2 and 3, a ladder rope retaining device 10 of the present invention comprises a support base 20 and a rotating base 30.

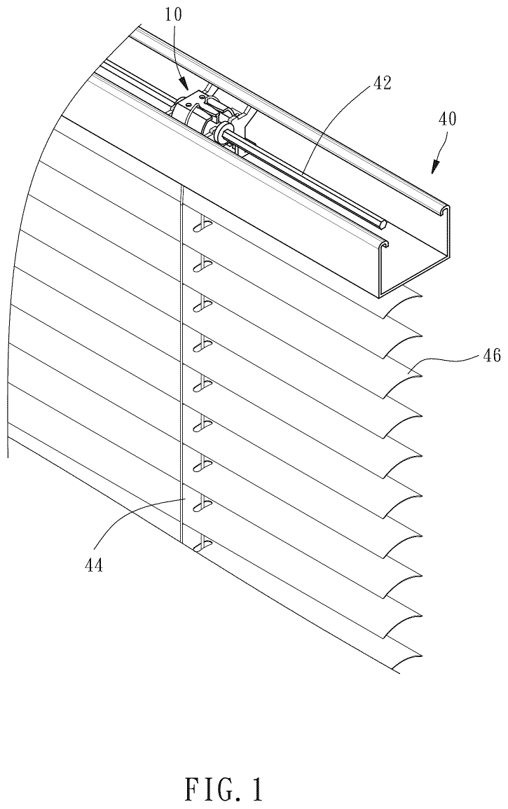

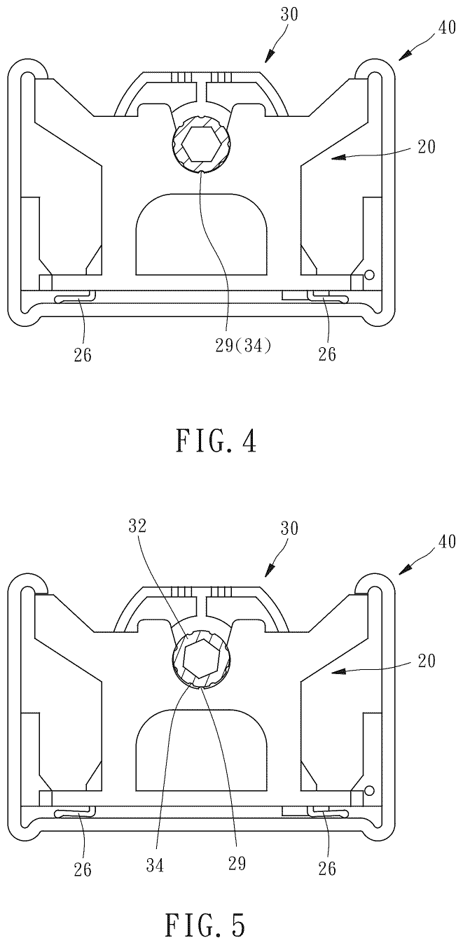

The support base 20 includes a bottom wall 22 and two straight walls 24. Two ends of the bottom wall 22 each have an elastic support portion 26 and two hollow portions 27. The elastic support portions 26 protrudes out of the bottom surface of the bottom wall 22. The hollow portions 27 are adjacent to two opposite sides of one of the elastic support portions 26 tier facilitating the elastic deformation of the elastic support portions 26. The straight walls 24 are integrally connected with two opposite sides of the bottom wall 22, and the straight walls 24 each have a pivot trough 28 with an opening facing upwards. The periphery wall of one of the pivot troughs 28 has a positioning bump 29. As shown in FIGS. 1 and 4, the support base 20 is assembled with a headrail 40 and abutted against the headrail 40 through the elastic support portions 26.

The rotating base 30 includes a pivot 31 and a ladder rope retaining portion 35. The pivot 31 has a shaft portion 32 and two disk portions 33. The outer surface of one end of the shaft portion 32 has a plurality of positioning recesses 34 arranged in an equally-spaced manner. The disk portions 33 are integrally connected with two ends of the shaft portion 32, and the disk portions 33 have diameters greater than the diameter of the shaft portion 32 and the diameter of the pivot trough 28. The ladder rope retaining portion 35 is integrally connected with the outer surface of the shaft portion 32, and the outer surface of the ladder rope retaining portion 35 has two slots 36. One end of each of the slots 36 is connected with a retaining hole 37. As shown in FIGS. 2 and 3, the two ends of the shaft portion 32 of the pivot 31 is assembled with the pivot troughs 28 of the support base 20 in such a way that the disk portions 33 is located at the outside of the straight walls 24 of the support base 20 for preventing the pivot 31 from separating from the pivot troughs 28 along its axial direction. In addition, the rotating base 30 further includes a driving hole 38 penetrating through the pivot 31. A driving shaft 42 is inserted into and engaged with the driving hole 38 for driving the rotating base 30 to rotate relative to the support base 20. When the rotating base 30 is used with two ladder ropes 44, the top ends of the ladder ropes 44 are inserted into the retaining holes 37 through the slots 36 and fastened to the rotating base 30 with knots, such that the ladder ropes 44 can be driven synchronously by the rotating base 30 to tilt the slats 46.

It can be seen from the above that when the rotating base 30 is rotated relative to the support base 20, the positioning recesses 34 are alternately engaged with and disengaged from the positioning bump 29 of the support base 20, As the rotating base 30 is rotated until the positioning recesses 34 are disengaged from the positioning bump 29, as shown in FIG. 5, the shaft portion 32 of the pivot 31 pushes against the positioning bump 29 of the support base 20, such that the support base 20 becomes deformed elastically by using the elastic support portions 26 to be abutted against the headrail 40. Thereafter, when the rotating base 30 is rotated until one of the positioning recesses 34 is engaged with the positioning bump 29, as shown in FIG. 4, the support base 20 restores its original state by means of the elastic rebound force provided by the elastic support portions 26. Therefore, the ladder rope retaining device 10 of the present invention has a clear operating feel during rotation of the rotating base 30, thereby enhancing hand feel of a user during adjusting angle of the slats 46.

What is claimed is:

1. A ladder rope retaining device for a venetian blind, comprising:
a support base including a bottom wall and two straight walls connected with two opposite sides of the bottom wall, two ends of the bottom wall each having an elastic support portion protruding out of a bottom surface of the bottom wall, the straight walls both having pivot troughs, a periphery wall of one of the pivot troughs having a positioning bump; and
a rotating base including a pivot pivotally disposed in the pivot troughs of the support base and a ladder rope retaining portion formed on an outer surface of the pivot, the outer surface of the pivot having a plurality of the positioning recesses arranged in an equally-spaced manner, wherein when the rotating base is rotated relative to the support base, the positioning recesses of the rotating base are alternately engaged with and disengaged from the positioning bump of the support base.

2. The ladder rope retaining device as claimed in claim 1, wherein the pivot has a shaft portion pivotally disposed in the pivot troughs of the support base and having the positioning recesses, and two disk portions connected with two ends of the shaft portion and located at an outside of the straight walls of the support wall and having diameters greater than a diameter of the shaft portion and diameters of the pivot troughs.

3. The ladder rope retaining device as claimed in claim 2, wherein the rotating base further includes a driving hole penetrating through the shaft portion.

4. The ladder rope retaining device as claimed in claim 1, wherein the bottom wall further has two hallow portions adjacent to the elastic support portions.
